(19) United States
(12) Patent Application Publication
(10) Pub. No.: US 2026/0100648 A1
(43) Pub. Date: Apr. 9, 2026

(54) MULTI-PHASE CURRENT BALANCING CIRCUIT AND METHOD

(71) Applicant: GLOBALFOUNDRIES U.S. Inc., Malta, NY (US)

(72) Inventors: Matthias HOFFMANN, Dresden (DE); Karsten TROELLER, Radeberg (DE)

(21) Appl. No.: 18/908,590

(22) Filed: Oct. 7, 2024

(51) Int. Cl. H02M 3/158

(52) U.S. Cl. CPC H02M 3/1584

(57) ABSTRACT

A multi-phase circuit includes a plurality of phases respectively corresponding to a plurality of clock phases. To balance respective output currents from the phases, for each phase: in response to an occurrence of a sampling time of that phase, a measurement signal corresponding to a value at the sampling time of the current for that phase is produced using a sampling circuit and provided to the other phases, other measurement signals from the other phases are received, an indicator signal according to whether the measurement signal is greater than an average of the other measurement signals is produced using a comparator circuit, and the output current of the phase is adjusted according to the indicator signal. The plurality of phases may include three or more phases.

### FIELD OF THE DISCLOSURE

The present disclosure relates to load balancing, and in particular to balancing respective output currents of phases of a multi-phase power supply according to an average of the output currents.

### BACKGROUND

A multi-phase electronic circuit may combine outputs of a plurality of subcircuits to generate an output. The plurality of subcircuits may be switching circuits respectively controlled according to a plurality of clock phases of a common clock signal, and in such cases the subcircuits may be referred to as phases. The multi-phase electronic circuit may be a switch-mode power supply (SMPS).

To optimize the efficiency, reliability, and capability of the multi-phase circuit, a balancing operation may be performed so that the current of each phase is roughly the same as the corresponding current of each of the other phases. This may be accomplished by controlling the phase to reduce its current when that current is greater than an average of the corresponding currents of the phases, and controlling the phase to increases its current when that current is less than the average of the corresponding currents of the phases.

Accordingly, a need exists for fast, power-efficient circuits and methods to determine whether a current of a phase is greater than an average of corresponding currents of the other phases, and to control the phase to reduce or increase its current according to whether it is greater or less that that average.

### SUMMARY

Embodiments of the present disclosure relate to circuits and methods for controlling a multi-phase electronic circuit including a plurality of phases. In particular, embodiments determine for each active phase in the multi-phase electronic circuit whether a current of that phase is greater than or less than an average of corresponding currents of all the phases or, equivalently, of the other phases.

In an embodiment, a balancing circuit comprises a plurality of sampling circuits and a plurality of comparator circuits. The plurality of sampling circuits produce a plurality of measurement signals corresponding to a plurality of phases of a multi-phase circuit, respectively, each sample circuit configured to generate the corresponding measurement signal according to a measured current of the corresponding phase and a clock phase used to generate the measured current from among a plurality of clock phases of the multi-phase circuit. The plurality of comparator circuits produce a plurality of indicator signals respectively corresponding to the plurality of phases, each comparator circuit configured to produce the corresponding indicator signal according to a comparison of the measurement signal for the corresponding phase to an average of the measurement signal for other phases of the plurality of phases. The measured current of each phase corresponds to a current of an output of that phase, and each phase of the plurality of phases is configured to adjust the current of the output of that phase in response to the corresponding indicator signal.

In an embodiment, a method comprises performing, for each phase of a plurality of phases of a multi-phase circuit, steps comprising: in response to an occurrence of a sampling time of that phase, produce a measurement signal corresponding to a value at the sampling time of the current for that phase among the plurality of currents, provide the measurement signal to other phases of the plurality of phases, receive other measurement signals from the other phases, determine an indicator signal according to whether the measurement signal is greater than or less than an average of the other measurement signals, and adjust the current according to the indicator signal. The plurality of phases respectively correspond to a plurality of clock phases of the multi-phase circuit.

In embodiments, the plurality of phases includes three or more phases.

In embodiments, for each phase, producing the measurement signal comprises sampling a droop voltage of a driver circuit used to produce the current.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention. In the drawings, like reference numerals refer to like features in the various views.

FIG. 1 illustrates a multi-phase electronic circuit according to an embodiment.

FIG. 2 illustrates components comprising a multi-phase current balancing circuit according to an embodiment.

FIG. 3A illustrates an averaging auto-zero comparator during an offset cancellation operation according to an embodiment.

FIG. 3B illustrates an averaging auto-zero comparator during a comparison operation according to an embodiment.

FIG. 4 includes waveforms illustrating operation of a multi-phase current balancing circuit according to an embodiment.

FIG. 5 illustrates a process for balancing currents output by phases of a multi-phase electronic circuit according to an embodiment.

### DETAILED DESCRIPTION

Illustrative embodiments of the present disclosure will be described below in more detail with reference to the accompanying drawings. The inventive features may, however, be embodied in different forms and should not be construed as limited to the embodiments set forth herein. Rather, these embodiments are provided so that this disclosure will be thorough and complete, and will fully convey the scope of the present claims to those skilled in the art. Throughout the disclosure, like reference numerals refer to like parts throughout the various figures and embodiments.

It will be understood that, although the terms “first” and/or “second” may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element. Furthermore, in the following, a “set” of items refers to one or more of the items, and a “plurality” of items refers to two or more of the items.

The drawings are not necessarily to scale and in some instances, proportions may have been exaggerated in order to clearly illustrate features of the embodiments.

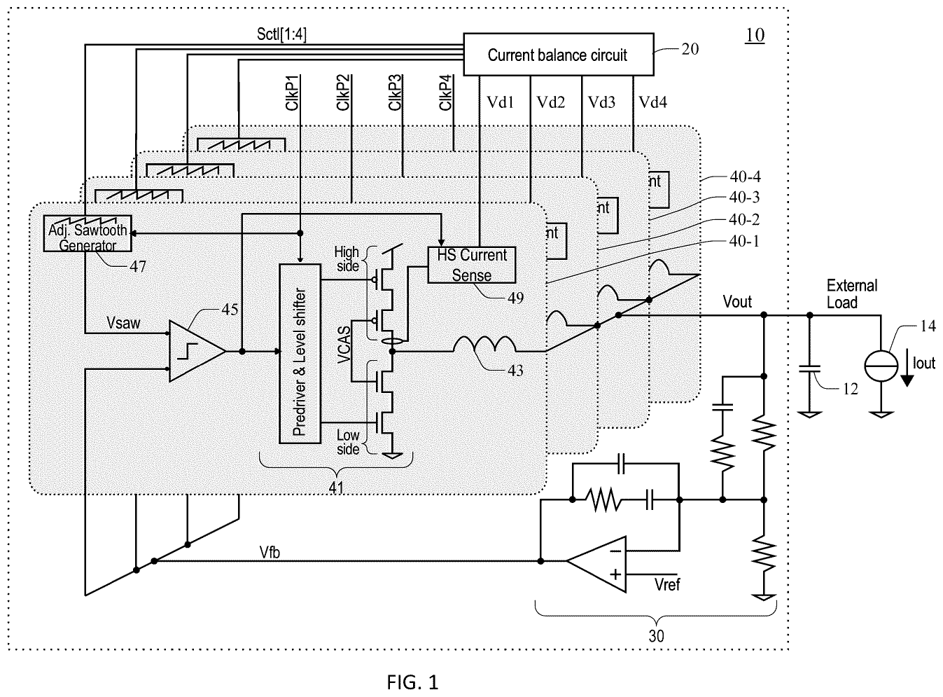

FIG. 1 illustrates a multi-phase electronic circuit, here a Switched-Mode Power Supply (SMPS) 10, according to an embodiment. The SMPS 10 supplies an output voltage Vout to an external load 14 by way of a filter capacitor 12.

Although the invention will be described with reference to the SMPS 10, which is a buck converter, embodiments are not limited to buck converters or to SMPSs in general.

The SMPS 10 comprises first, second, third, and fourth phases 40-1, 40-2, 40-3, and 40-4, the outputs of which are combined to provide the output voltage Vout. A feedback circuit 30 provides a feedback voltage Vfb according to a comparison performed using a reference voltage and a voltage of the output voltage Vout. A current balancing unit 20 produces sawtooth control signals Sctl[1:4] to respectively control currents of the first, second, third, and fourth phases 40-1, 40-2, 40-3, and 40-4 based on first, second, third, and fourth droop voltage Vd1, Vd2, Vd3, and Vd4 respectively provided therefrom. Magnitudes of the first through fourth droop voltage Vd1 through Vd4 respectively correspond to currents output by the first through fourth phases 40-1 through 40-2.

Operation and configuration of the filter capacitor 12 and feedback circuit 30 are varied and widely-known in the related arts, and accordingly a detailed description thereof is omitted for brevity.

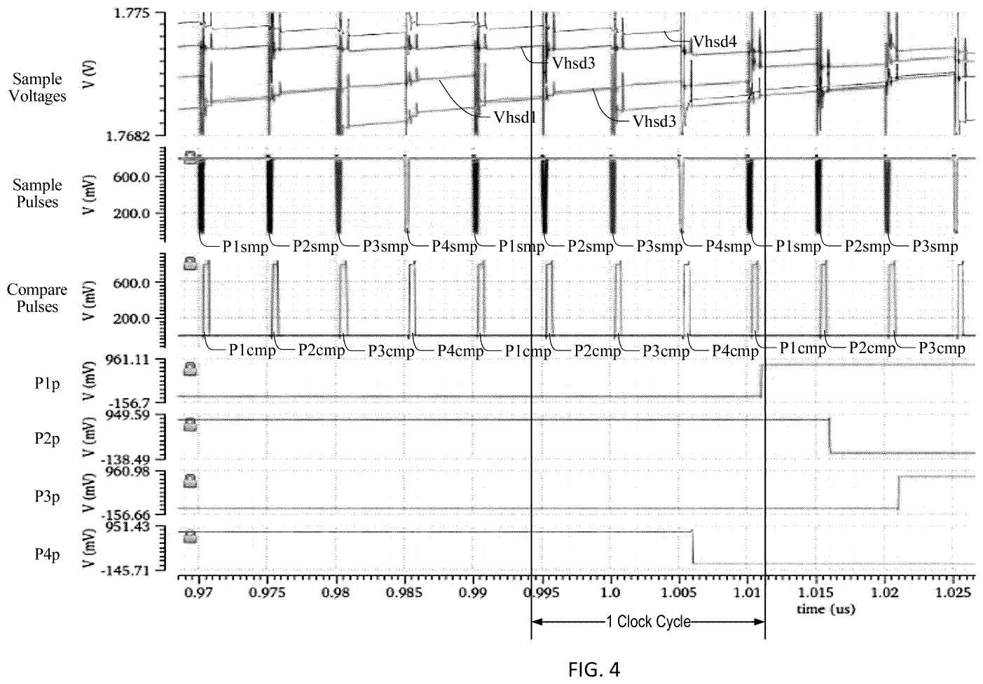

Each of the phases 40-1 through 40-4 comprises a driver circuit 41 having a high side and a low side, an energy-storage inductor 43, a comparator circuit 45, an adjustable sawtooth generator circuit 47, and a high-side current sense circuit 49. Operation and composition of the driver circuit 41, energy-storage inductor 43, and comparator circuit 45 are varied and widely-known in the related arts, and accordingly a detailed description thereof is omitted for brevity. The driver circuit 41 shown in FIG. 4 is a half-bridge driver having a high side and a low side. Note that the driver circuit 41 shown in FIG. 1 has a cascode output circuit that uses a cascode voltage VCAS, but embodiments are not limited thereto.

The amount of current output by each the phases 40-1 through 40-4 is determined by a duty cycle of that phase's driver circuit 41, which is determined by the comparator circuit 45 based on the feedback voltage Vfb provided to all the phases and the sawtooth signal Vsaw produced by that phase's sawtooth generator circuit 47.

An amplitude, a slope, or both of the sawtooth signal Vsaw produced by each phase's sawtooth generator circuit 47 is determined according to the respective one of the sawtooth control signals Sctl[1:4] for that phase.

In particular, in response to the current balance circuit 20 determining that a current of a phase is greater than an average of corresponding currents of the other phases, the current balance circuit 20 controls the respective one of the sawtooth control signals Sctl[1:4] for that phase to alter the amplitude, a slope, or both of the sawtooth signal Vsaw of that phase so as to reduce the duty cycle of that phase's driver circuit 41 so that the current output from that phase is reduced, and in response to the current balance circuit 20 determining that the current of the phase is less than the average of the corresponding currents of the other phases, the current balance circuit 20 controls the respective one of the sawtooth control signals Sctl[1:4] for that phase to alter the amplitude, a slope, or both of the sawtooth signal Vsaw of that phase so as to increase the duty cycle of that phase's driver circuit 41 so that the current output from that phase is increased.

In this manner, the current balance circuit 20 controls the phases so that the current of each phase is substantially the same as the corresponding currents of the other phases. The currents may correspond to correlate with currents of outputs of the phases.

The high-side current sense circuit 49 of each phase generates that phase's one of the first through fourth droop voltage Vd1 through Vd4, referred to here as that phase's droop voltage. The droop voltage is taken from across the high side of the driver circuit 41 and corresponds to a difference between the supply voltage to the driver circuit 41 and the voltage being output by the driver circuit 41. Accordingly, a phase's droop voltage is proportional to the current flowing to the energy-storage inductor 43 through the high side of that phase's driver circuit 41.

In embodiments, the droop voltage is sampled immediately before the high side of the driver circuit is turned off, and accordingly corresponds to the peak current flowing through the high side during that cycle of operation of the phase. Therefore, balancing the first through fourth droop voltages Vd1 through Vd4 to be substantially the same (e.g., to each be the substantially the same as the average of all them) results in the currents through the phases being balanced.

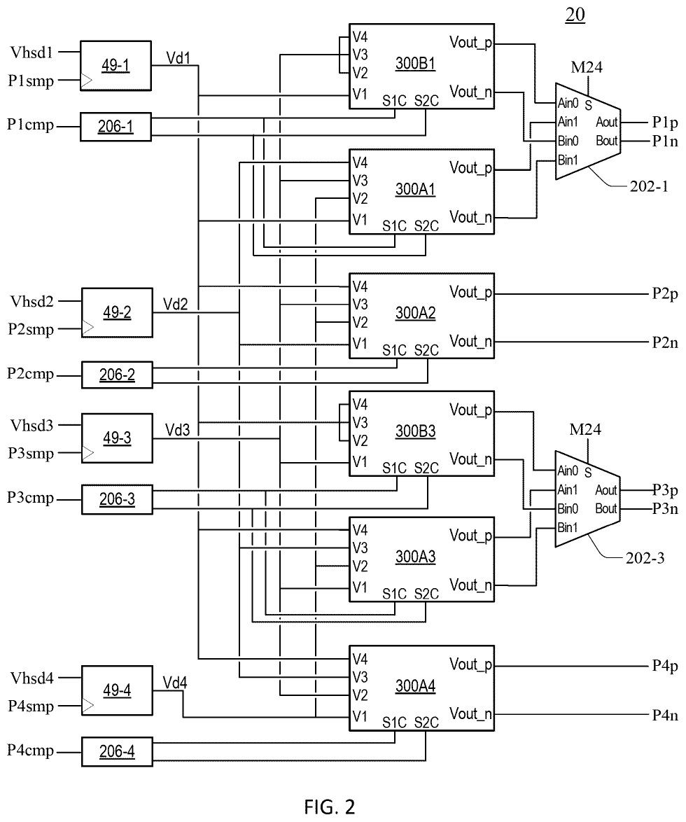

FIG. 2 illustrates components comprising a multi-phase current balancing circuit 20 according to an embodiment. The components include first, second, third, and fourth four-phase averaging auto-zero comparators (hereinafter, AAZ comparators) 300A1, 300A2, 300A3, and 300A4, first and second two-phase AAZ comparators 300B1 and 300B3, first and second multiplexers 202-1 and 202-2, and first, second, third, and fourth switch controller circuits 206-1, 206-2, 206-03, and 206-4.

In the illustrated embodiment, the first through fourth four-way AAZ comparators 300A 1 through 300A4 are used when all four phases of the SMPS 10 are active, and the first and second two-way AAZ comparators 300B1 and 300B3 are used when only two phases (specifically, the first and third phrases) of the SMPS 10 are active, such as when the SMPS 10 operates in a reduced power state. Based on a mode signal M24, the first multiplexer 202- determines whether the outputs of the first two-way AAZ comparators 300B1 or the outputs of the first four-way AAZ comparators 300A1 are output for use in controlling the current output by the first phase 40-1, and the second multiplexer 202-2 determines whether the outputs of the third two-way AAZ comparators 300B3 or the outputs of the third four-way AAZ comparators 300A3 are output for use in controlling the current output by the third phase 40-3.

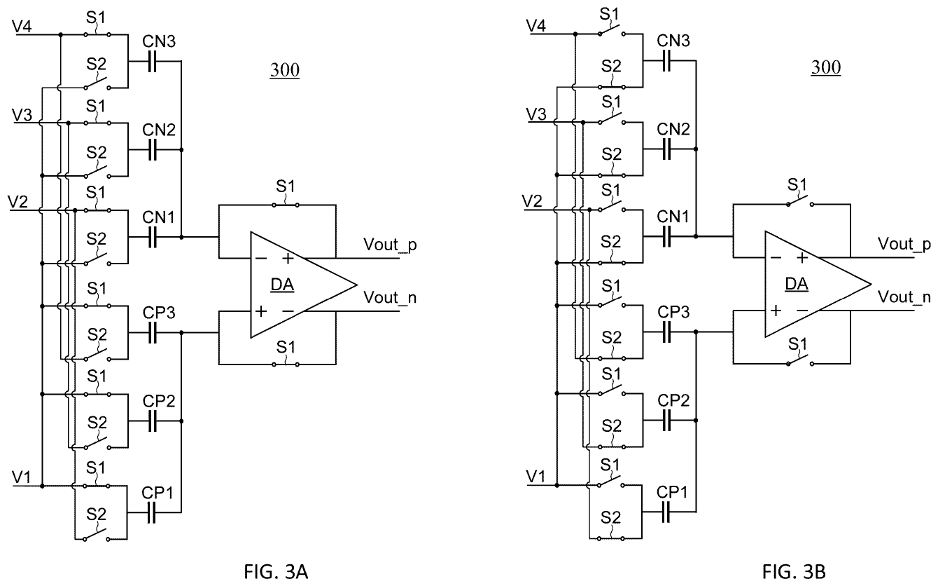

In embodiments, each of the first and second two-way AAZ comparators 300B1 and 300B3 and the first through fourth four-way AAZ comparators 300A1 through 300A4 includes the AAZ comparator 300 of FIG. 3. In such embodiments, as shown in FIG. 2, each of the first and second two-way AAZ comparators 300B1 and 300B3 is configured with inputs V2 through V4 tied together so as to compare a first droop voltage on input V1 to a second droop voltage on inputs V2 through V4s, while each of the first through fourth four-way AAZ comparators 300A1 through 300A4 is configured with each of inputs V1 through V4 receiving a respective droop voltage so as to compare a first droop voltage on V1 to an average of second through fourth droop voltages on V2 through V4.

Note that mathematically, determining whether the first droop voltage is greater than or less than the average of the second through fourth droop voltages is equivalent to determining whether the first droop voltage is greater than or less than the average of all four droop voltages.

The first through fourth switch controller circuits 206-1 through 206-4 generate respective first and second switch signals S1C and S2C according to first, second, third, and fourth compare signals P1cmp, P2cmp, P3cmp, and P4cmp, respectively. Each pair of first and second switch signals SIC and S2C is controlled so that a first set of switches controlled by one of the pair are on when a second set of switches controlled by the other of the pair are off, and vice-versa.

In embodiments, the first and second switch signals SIC and S2C are controlled so that a dead time during which both sets of switches are off exists between when the first set of switches are on and when the second set of switches are on, as is widely known in the art.

Operation of the first set of switches and the second set of switches is further explained below with reference to FIG. 4.

Also shown in FIG. 2 are first, second, third, and high-side current sense circuits 49-1, 49-2, 49-3, 49-4 respectively corresponding to high-side current sense circuits 49 of the first through fourth phases 40-1 through 40-4. The first through fourth high-side current sense circuits 49-1 through 49-4 produce first through fourth droop voltages Vd1 through Vd4 by sampling first, second, third, and fourth high side voltage drops Vhsd1, Vhsd2, Vhsd3, and Vhsd4 of the first through fourth phases 40-1 through 40-4 at a time indicated by first through fourth sampling signals P1smp through P4smp, respectively, as is further explained below with reference to FIG. 4.

FIGS. 3A and 3B illustrate operation of an AAZ comparator 300 according to an embodiment. Specifically, FIG. 3A illustrates a configuration of the AAZ comparator 300 during an offset cancellation operation, and FIG. 3B illustrates a configuration of the AAZ comparator 300 during a comparison operation.

During the offset cancellation operation shown in FIG. 3A, a first set of switches S1 are closed and a second set of switches S2 are open. Accordingly, while the positive and negative outputs of the differential amplifier DA are being fed back to the negative and positive inputs of the differential amplifier DA, respectively, to cancel any offset voltage of the differential amplifier DA; the first, second, and third negative-side capacitors CN1, CN2, and CN3 are charged by connecting them to voltages of the second, third, and fourth inputs V2, V3, and V4, respectively; and the first, second, and third positive-side capacitors CP1, CP2, and CP3 are all charged by connecting them to a voltage of the first input V1.

As a result, the combined charge of a first capacitor bank comprising the first, second, and third negative-side capacitors CN1, CN2, and CN3 and the combined charge of a second capacitor bank comprising the of the first, second, and third positive-side capacitors CP1, CP2, and CP3 are each given by:

$$Q = {\sum }_{k = 1}^{n} {Q}_{k} = {\sum }_{k = 1}^{n} \frac{C}{n} {V}_{k} \qquad Equation 1$$

wherein Q is the combined charge, n is the number of capacitors in the bank, C is the capacitance of each capacitor in the bank, Vₖ is a voltage provided the k^{th} capacitor of the bank, and Qₖ is the resulting charge on the k^{th} capacitor.

Accordingly, a voltage Vᵢₙ₁ on a first input of the differential comparator DA is equal to the sum of the voltages of the second, third, and fourth inputs V2, V3, and V4 divided by the number n of said voltages, and a voltage Vᵢₙ₂ on a second input of the differential comparator DA is equal to the n time the voltage of the first input V1 divided n. That is:

$${V}_{i n 1} = \frac{V 2 + V 3 + V 4}{3} , {V}_{i n 2} = \frac{3 \times V 1}{3} \qquad Equation 2$$

so that Vᵢₙ₁ provided to a first input of the differential comparator DA corresponds to an average of the voltages of the second, third, and fourth inputs V2, V3, and V4 and Vᵢₙ₂ provided to a second input of the differential comparator DA corresponds to the voltage of the first input V1.

During the compare operation shown in FIG. 3B, a first set of switches S1 are open and a second set of switches S2 are closed. Accordingly, the differential amplifier DA operates to amplify a difference between respective voltages of its negative and positive inputs; the first, second, and third positive-side capacitors CP1, CP2, and CP3 are connected to the voltages of the second, third, and fourth inputs V2, V3, and V4; respectively, and the first, second, and third negative-side capacitors CN1, CN2, and CN3 are connected to the voltage of the first input V1.

Accordingly, values of the positive and negative outputs Vout_p and Vout_n of the differential comparator DA correspond to a result of comparing the voltage of the first input V1 to an average of the voltages of the second, third, and fourth inputs V2, V3, and V4.

In an embodiment, the positive output Vout_p of a differential amplifier DA being greater than the negative output Vout_n of that DA indicates that the current of the phase corresponding to the voltage provided to the first input V1 is greater than the average of the current(s) of the phase(s) corresponding to the voltage provided to the second through fourth inputs V2, V3, and V4, and the positive output Vout_p of the differential amplifier DA being less than the negative output Vout_n of that differential amplifier DA indicates that the current of the phase corresponding to the voltage provided to the first input V1 is less than the average of the current(s) of the phase(s) corresponding to the voltage provided to the second through fourth inputs V2, V3, and V4.

In an embodiment, the positive and negative outputs Vout_p and Vout_n of the differential amplifier DA are used to generate digital signals for the corresponding phase, here shown as first, second, third, and fourth phase positive signals P1p, P2p, P3p, and P4p and first, second, third, and fourth phase negative signals P1n, P2n, P3n, and P4n, with each of first through fourth phase positive signals P1p through P4p having a value of 1 when the current of the respective phase is greater than the average of the other currents and a value of 0 otherwise, and each of first through fourth phase negative signals P1n through P4n having a value of 1 when the current of the respective phase is less than the average of the other currents and a value of 0 otherwise.

In some embodiments, only one of the first through fourth phase positive signals P1p through P4p or the first through fourth phase negative signals P1n through P4n are produced for each phase.

FIG. 4 includes waveforms illustrating operation of a multi-phase current balancing circuit according to an embodiment. In FIG. 4, four active phases are shown, but embodiments are not limited thereto.

As can be seen in FIG. 4, the high-side currents being measured by first, second, third, and fourth the high-side droop voltages Vhsd1, Vhsd2, Vhsd3, and Vhsd4 in the first through fourth phases are phase shifted with respect to each other. Accordingly, each of the first through fourth high-side droop voltages Vhsd1 through Vhsd4 must be sampled at a different point in the clock cycle in order to be sampled at a same first relative point in the operational cycle of the respective phase.

In embodiments, each of the first through fourth high-side droop voltages Vhsd1 through Vhsd4 are sampled just before corresponding high-side driver of the corresponding phase is turned off, as indicated by the first, second, third, and fourth phase sampling signals P1smp, P2smp, P3smp, and P4smp, which are respectively disposed at 0, 90, 180 and 270 degree relative offsets within a clock cycle.

The comparison of each phase's current to the average current of all the phases is also performed at a same second relative point in the operational cycle of the respective phase. Here, the comparison for a phase is performed shortly after the current for that phase is samples, as indicated by the first, second, third, and fourth phase compare signals P1cmp, P2cmp, P3cmp, and P4cmp.

As a result, the indications of whether each phases' current output should be raised or lowered, shown in FIG. 4 as first through fourth phase positive signals P1p through P4p, are updated at a same third relative point in the operational cycle of the respective phase.

When the n^{th} phase positive signal P1n of the n^{th} phase indicates that the current being output by the n^{th} phase is greater than the average of the currents being output by the other phases, the corresponding sawtooth control signal Sctl[n] is adjusted to decrease the current being output by the n^{th} phase. When the n^{th} phase positive signal P1n of the n^{th} phase indicates that the current being output by the n^{th} phase is less than the average of the currents being output by the other phases, the corresponding sawtooth control signal Sctl[n] is adjusted to increase the current being output by the n^{th} phase.

In this manner, the peak value of the current being output by the phases is balanced to have substantially the same value. In embodiments, the peak current being output strongly corresponds with the average current being output.

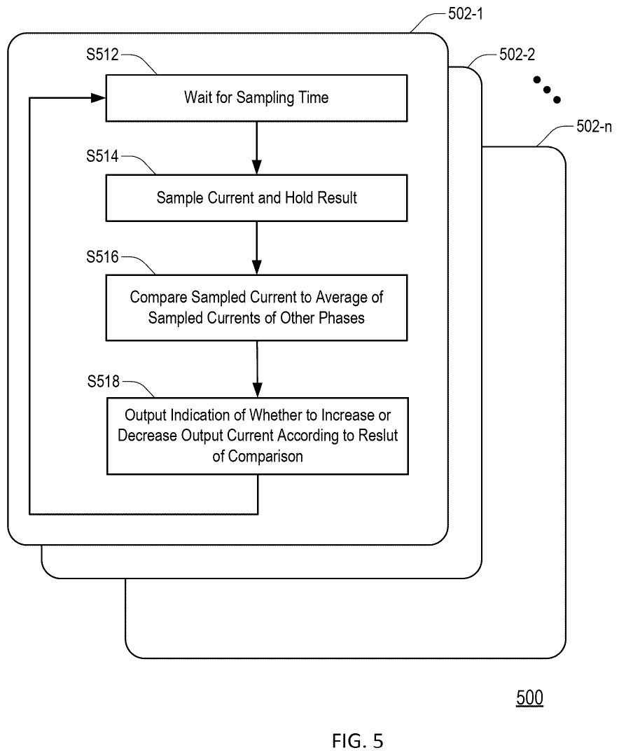

FIG. 5 illustrates a process 500 for balancing currents output by phases of a multi-phase electronic circuit according to an embodiment. The multi-phase electronic circuit may be a multi-phase SMPS having a plurality of phases such as the SMPS 10 of FIG. 1, each phase operating according to a different clock phase. For the process 500 illustrated in FIG. 5, the multi-phase electronic circuit has three or more phases.

The process 500 includes n subprocess, here first and second through n^{th} subprocess 502-1, 502-2, . . . , 502-n, wherein each subprocess corresponds to a phase of the multi-phase electronic circuit.

In an embodiment, each of the second through n^{th} subprocess 502-2 through 502-n performs the steps shown in FIG. 5 for the first subprocess 502-1 and described below, but carries out the steps at different times according to the clock phases used by each phase.

At step S512, the first subprocess 502-1 waits for a sampling time of the corresponding phase. The sampling time may correspond to the first phase sampling signal P1smp shown in FIG. 4.

In embodiments, the sampling time corresponds to a time of a peak value for a current of the corresponding phase. For example, the sampling time may be a time immediately before a driver circuit used to generate the output of the phase is turned off, or a time immediately before one side of a half-bridge driver circuit used to generate the output of the phase is turned off. When the sampling time occurs, the first subprocess 502-1 proceeds to step S514.

At step S514, the first subprocess 502-1 samples and holds a measurement of a current of the corresponding phase. The measurement may be of a droop voltage across a circuit used to generate the output of the phase. For example, the measurement may be of droop voltage of one side of a half-bridge driver circuit used to generate the output of the phase. In embodiments, the sampled value is held until the next sampling time for the corresponding phases; that is, until the first subprocess 502-1 returns to step S514.

Each of the first through n^{th} subprocesses 502-1 through 502-n provides its respective measurement to the other subprocesses.

At step S516, the first subprocess 502-1 operates to perform a comparison of its measurement to the average of the measurements received from the other subprocesses. The comparison determines whether the measurement taken by the first subprocess 502-1 is greater than or less than the average of the measurements received from the other subprocesses.

At step S518, the first subprocess 502-1 outputs an indication of whether the output current of its corresponding phase should be increased or decreased based on the result of the average-and-compare operation performed in step S516. The indication may correspond to the first phase positive signal P1p shown in FIG. 4.

The indication may be latched so as to be maintained until the next time the first subprocess 502-1 performs step S518.

After outputting the indication, the first subprocess 502-1 returns to step S512.

In embodiments, a multi-phase circuit includes a plurality of phases respectively corresponding to a plurality of clock phases. To balance respective output currents from the phases, for each phase: in response to an occurrence of a sampling time of that phase, a measurement signal corresponding to a value at the sampling time of the current for that phase is produced using a sampling circuit and provide to the other phases, other measurement signals from the other phases are received, an indicator signal according to whether the measurement signal is greater than or less than an average of the other measurement signals is produced using a comparator circuit, and the output current of the phase is adjusted according to the indicator signal in order to balance it with the output currents of the other phases. The plurality of phases may include three or more phases.

As described above, embodiments compare a measured current in a phase of a multi-phase circuit having a plurality of phases with an average of corresponding measured currents in the other phases of the plurality of phases in a single step, and uses the result of the comparison to balance the output current of the phase with the respective output currents of the other phases.

In embodiments, the plurality of phases includes three or more phases.

The comparison may be performed using respective voltages corresponding to the measured currents of the phases.

The measured current may be a peak current during a cycle of the corresponding phases, and may be measured by measuring a droop voltage of a driver used to produce the output current. The peak currents may be out of phase with each other in accordance with the respective clock phases used by the phases. The droop voltage may be a droop voltage across one side of a half-bridge driver, such as a high side or a low side.

By effectively performing the averaging of the measured currents of the other phases and the comparison with the measured current of the phases to that average in a single step, embodiments improve the speed and decrease the power consumption compared to current-balancing solutions known in the art. Furthermore, embodiments eliminate the need for a separate circuit, such as a summing circuit, for generating a signal corresponding to the average of the measured currents.

Aspects of the present disclosure have been described in conjunction with the specific embodiments thereof that are proposed as examples. Numerous alternatives, modifications, and variations to the embodiments as set forth herein may be made without departing from the scope of the claims set forth below. Accordingly, embodiments as set forth herein are intended to be illustrative and not limiting.

1. A balancing circuit comprising:
a plurality of sampling circuits producing a plurality of measurement signals corresponding to a plurality of phases of a multi-phase circuit, respectively, each sample circuit configured to generate the corresponding measurement signal according to a measured current of the corresponding phase and a clock phase used to generate the measured current from among a plurality of clock phases of the multi-phase circuit; and
a plurality of comparator circuits producing a plurality of indicator signals respectively corresponding to the plurality of phases, each comparator circuit configured to produce the corresponding indicator signal according to a comparison of the measurement signal for the corresponding phase to an average of the measurement signal for other phases of the plurality of phases,
wherein the measured current of each phase corresponds to a current of an output of that phase, and
wherein each phase of the plurality of phases is configured to adjust the current of the output of that phase in response to the corresponding indicator signal.

2. The balancing circuit of claim 1, wherein the plurality of phases includes three or more phases.

3. The balancing circuit of claim 1, wherein a comparator circuit of the plurality of comparator circuits includes an auto-zeroing comparator circuit, the auto-zeroing comparator circuit comprising:
a differential amplifier;
a first plurality of capacitors each having a first end coupled to a negative input of the differential amplifier;
a second plurality of capacitors each having a first end coupled to a positive input of the differential amplifier;
a first plurality of switches controlled by a first switch control signal, the first plurality of switches including:
a plurality of first other input switches configured to provide the measurement signals for the other phases to second ends of the first plurality of capacitors, respectively, when the first switch control signal is asserted, and
a plurality of first self input switches configured to provide the measurement signal for the corresponding phase to second ends of the second plurality of capacitors, respectively, when the first switch control signal is asserted,
a second plurality of switches controlled by a second switch control signal, the second plurality of switches including:
a plurality of second other input switches configured to provide the measurement signals for the other phases to second ends of the second plurality of capacitors, respectively, when the second switch control signal is asserted, and
a plurality of second self input switches configured to provide the measurement signal for the corresponding phase to second ends of the first plurality of capacitors, respectively, when the second switch control signal is asserted;
wherein the indicator signal is determined according to the positive output, negative output, or both of the differential amplifier,
wherein the first switch control signal is de-asserted when the second switch control signal is asserted, and the second switch control signal is de-asserted when the first switch control signal is asserted.

4. The balancing circuit of claim 3, wherein the first plurality of switches further includes:
a first auto-zeroing switch configured to connect a positive output of the differential amplifier and the negative input of the differential amplifier when the first switch control signal is asserted,
a second auto-zeroing switch configured to connect a negative output of the differential amplifier and the positive input of the differential amplifier when the first switch control signal is asserted.

5. The balancing circuit of claim 1, wherein the measured current of each phase corresponds to a current supplied to an energy storage device of that phase through a driver circuit of that phase.

6. The balancing circuit of claim 5, wherein each sampling circuit of the plurality of sampling circuits is configured to sample a droop voltage across one or more components of a driver circuit of the corresponding phase and produced by the measured current of the corresponding phase.

7. The balancing circuit of claim 6, wherein each sampling circuit of the plurality of sampling circuits is configured to sample the droop voltage at a time immediately preceding a time at which the one or more components of the driver circuit are turned off.

8. The balancing circuit of claim 7, wherein for each phase, the time at which the one or more components of the driver circuit of that phase are turned off varies according to the clock phase corresponding to that phase.

9. The balancing circuit of claim 1, wherein each of the plurality of phases includes an adjustable sawtooth signal generator circuit, and
wherein adjusting the current of the output of each phase in response to the corresponding indicator signal includes adjusting a slope, an amplitude, or both of a sawtooth signal generated by the adjustable sawtooth signal generator circuit of that phase according to the corresponding indicator signal.

10. A method comprising:
for each phase of a plurality of phases of a multi-phase circuit:
in response to an occurrence of a sampling time of that phase, produce a measurement signal corresponding to a value at the sampling time of the current for that phase among the plurality of currents,
provide the measurement signal to other phases of the plurality of phases,
receive other measurement signals from the other phases,
determine an indicator signal according to whether the measurement signal is greater than an average of the other measurement signals, and
adjust the current according to the indicator signal,
wherein the plurality of phases respectively correspond to a plurality of clock phases of the multi-phase circuit.

11. The method of claim 10, wherein the plurality of phases includes three or more phases.

12. The method of claim 10, wherein for each phase, producing the measurement signal corresponding to the value at the sampling time of the current comprises sampling a droop voltage of a driver circuit used to produce the current.

13. The method of claim 12, wherein producing the measurement signal corresponding to the value at the sampling time of the current further comprises holding the sampled droop voltage until the next sampling time of that phase.

14. The method of claim 12, wherein the driver circuit comprises a half-bridge driver circuit, and the droop voltage corresponds to a voltage across a side of the half-bridge driver circuit.

15. The method of claim 14, wherein the sampling time corresponds to time immediately preceding a time at which the side of the half-bridge driver circuit is turned off.

16. The method of claim 10, wherein for each phase, determining the indicator signal comprises:
during a first period of time of that phase following the sampling time of that phase:
respectively providing the other measurement signals to second ends of a first plurality of capacitors, the first plurality of capacitors having first ends connected to a first polarity input of a differential amplifier corresponding to the phase, and
providing the measurement signal to second ends of a second plurality of capacitors, the second plurality of capacitors having first ends connected to a second polarity input of the differential amplifier; and
during a second period of time of that phase following the first period of time:
respectively providing the other measurement signals to second ends of the second plurality of capacitors,
providing the measurement signal to second ends of the first plurality of capacitors, and
determining the indicator signal according to one or more outputs of the differential amplifier;

17. The method of claim 16, wherein for each phase, determining the indicator signal comprises:
during the first period of time of that phase:
providing a first polarity output of the differential amplifier to the second polarity input of the differential amplifier, and
providing a second polarity output of the differential amplifier to the first polarity input of the differential amplifier.

18. The method of claim 10, wherein for each phase, adjusting the current according to the indicator signal comprised adjusting a slope, an amplitude, or both of a sawtooth signal of that phase according to the indicator signal.
